(19) United States
(12) Patent Application Publication
(10) Pub. No.: US 2010/0189848 A1
(43) Pub. Date: Jul. 29, 2010

(54) FOOD PACKAGING SYSTEM FOR EXTENDED SHELF LIFE

(76) Inventor: Ronald D. Mabry, Orchard Park, NY (US)

Correspondence Address: SIMPSON & SIMPSON, PLLC, 5555 MAIN STREET, WILLIAMSVILLE, NY, 14221-5406, US

(21) Appl. No.: 12/754,306

(22) Filed: Apr. 5, 2010

Related U.S. Application Data
(63) Continuation-in-part of application No. 11/897,495, filed on Aug. 30, 2007.
(60) Provisional application No. 60/849,719, filed on Oct. 5, 2006.

(51) Int. Cl. B65D 81/24; B65D 81/26; B65D 81/28; A23B 4/00; B65D 1/34

(52) U.S. Cl. 426/124; 426/129; 426/127; 206/557

(57) ABSTRACT

A packaging system for perishable food products, especially for meat products discharging residual blood and other natural fluids, comprising a tray and an outer tray closure film spanning the perimeter of the tray, wherein the tray possesses structural features for transmission of draining fluids away from the meat product extending the shelf-life of the packaged meat while avoiding the usual “browning” appearance. Instead, the natural redness and appetizing appearance or “bloom” properties of the meat product are maintained for enhanced customer acceptance. The outer film preferably incorporates at least a sufficient amount of a biostatic and/or biocidal agent. The tray includes an elevated meat supporting porous film, and a reservoir below the porous film for collecting descending fluids. The descending fluids are managed by a series of elevations and lower channels for collection/retaining the fluids in supporting relationship with the porous film.

### CROSS REFERENCE TO RELATED APPLICATION

This application is a continuation-in-part of U.S. patent application Ser. No. 11/897,495 filed on Aug. 30, 2007, which application claims priority from U.S. Provisional Application No. 60/849,719, filed Oct. 5, 2006, which applications are incorporated herein by reference in their entireties.

### FIELD OF THE INVENTION

This invention relates generally to food trays and packaging systems often used by retailers in displaying perishable foodstuffs. More specifically, the invention relates to food packaging trays and packaging systems which can incorporate biocidal/biostatic agents to extend the shelf life of perishable food items, such as meat, fish and poultry, and which comprise structural features for enhanced drainage and separation of natural fluids away from such foods to extend both shelf-life and appetizing appearance for better customer acceptance.

### BACKGROUND OF THE INVENTION

Packaging systems are known in the art for displaying foodstuff by retailers, such as fresh meat, fish and poultry, all of which continue to drain residual natural fluids, such as blood, water and other fluids after being packaged. These packaging systems are often intended for maintaining the freshness and appetizing appearance of uncooked and cooked meat, fish, poultry and other perishable items.

Packaging systems are known in the art, which include a base tray and an outer wrapper, for example. Meat, fish and poultry products often packaged in such disposable trays, however, usually continue to exude natural fluids and juices after being placed in display cases by retailers. Customer acceptance of such products is usually dependent on maintaining an appetizing appearance of the packaged food products. Fresh meat products, for example, packaged in such trays are often in direct contact with fluid absorbent pads. Consequently, such packaging methods provide more limited shelf lives and reduced customer acceptance because of the unsightly appearance of the meat product disposed in the residual fluids and the browning effect due to bacteria acting on proteins. Also, a build-up of liquid in the package can spill when the meat product is unpacked or if the package is damaged in transit. To remedy such problems, packaging systems have been developed, such as disclosed in patent applications: EP-A-0 182 139, GB-A-1 168925 and EP-A-0 544 562; in patents: FR 2 688 474 and JP 06239351 A; in utility model DE 9013898.8; and U.S. Pat. No. 5,833,894.

Other perishable food packaging systems relating to managing drainage fluids have been disclosed in U.S. Pat. No. 4,576,278; U.S. Pat. No. 4,949,897; U.S. Pat. No. 5,655,708; and, in FR 2 782 985 A1. Such methods have proven to be somewhat effective in maintaining a temporary separation of drainage fluids from meat products, but are often ineffective in preventing fluids from recontacting the packaged meat product during transport after purchase or during shipping.

Such methods have failed to provide a substantial increase in the shelf-life of meat products. Microorganisms on the surface of the meat tend to discolor fresh meat products resulting in a loss of appetizing redness or “bloom”. As the drainage fluid is removed from the meat product by an absorbent pad, for example, potentially harmful microorganisms may develop. As the package is moved on product shelves or at the checkout counter drainage fluids containing microorganisms can be returned back to the surface of the meat product. Further, packaged meat products may reabsorb drainage fluids, causing recontamination of the packaged meat product. In sum, many of the earlier packaging systems failed to effectively manage liquid drainage from fresh meat products for extending shelf life and maintaining the desired appetizing appearance often critical for customer acceptance.

Accordingly, there is a need for an improved packaging system for extending the shelf life of fresh and cooked perishable foodstuff, e.g., meat, fish, pork and poultry products, and the like, and which allows natural fluids to freely drain away from the foodstuff while minimizing recontamination, inhibiting the development of microorganisms, resist meat discoloration (browning) while maintaining product “bloom” for extended shelf-life and customer acceptance.

### SUMMARY OF THE INVENTION

It is therefore a principal object of the invention to provide food packaging trays comprising novel structural features, such as a porous film elevated from the floor of the tray and a lower liquid reservoir positioned below the elevated film which performs as a sump or reservoir for collecting drainage fluid away from packaged perishable foodstuff while providing support for the packaged product suspended on the porous film.

The present invention broadly comprises a packaging system, including a tray having a reservoir or sump, a reservoir floor; and a porous film elevated from the reservoir floor, wherein the porous film optionally incorporates a first biocidal and/or biostatic agent, and is arranged to suspend a food product above the reservoir floor. In yet a further embodiment, the invention contemplates food packaging trays, as previously disclosed, in combination with package closure system, including a non-porous outer film preferably adapted to engage with and cover the food product positioned on the elevated porous film. The outer film preferably includes therein a second biocide/biostatic agent. When the outer closure film engages the packaged meat product the biocidal agent therein operates to extend shelf life of the packaged meat product by minimizing browning due to microorganisms while maintaining natural redness and bloom for a more appetizing appearance and customer acceptance.

The porous film supporting the foodstuff above the floor of the sump can be virtually any type of porous film, such as a one-way porous film restricting the transmission of liquid mainly in one direction into the lower fluid sump/reservoir, or alternatively, a two-way porous film allowing the transmission of fluid across in ether direction.

In yet a further aspect of the invention, the reservoir floor includes a plurality of ridges or elevations of any appropriate geometrical design together with a plurality of lower channels or grooves at the base of the elevations forming the floor of the tray, for receiving natural juices and fluids. The elevations between the channels or grooves are of suitable height to assist in the support of the food product suspended on the porous film, especially when supporting heavier foodstuff products, including meat products.

The packaging systems of the invention may include one or more biocidal and/or biostatic agent(s) imbibed onto the films, especially food grade agents for killing and/or inhibiting microorganism, such as bacteria, viruses, fungi, and the like. This may include known biocidal and/or biostatic agents, such as for an example, triclosan, or other food grade biocides or biostatic agents capable inhibiting the development of microorganisms that discolor the food product due to a “browning” effect and loss of “bloom”, wherein the appetizing natural red color of the packaged meat product is diminished, shortening product shelf-life and resulting in loss of appetizing appearance and concomitant diminished customer acceptance.

The present invention further comprises a packaged meat product including a tray, a meat product arranged within said tray, and an outer film incorporating a first biocide and/or biostatic agent(s) arranged to cover the meat product, and more particularly, have at least a portion of a surface of the outer film in contact with a top surface of the meat product. The tray further includes a sump or reservoir formed from the floor and tray sidewalls engaged thereto, and a porous film elevated from the floor of the tray to suspend the meat product above the reservoir floor. Optionally, the porous film may have a biocidal and/or biostatic agent imbibed thereon.

Therefore, it is a principal object of the invention to provide a packaging system for perishable foodstuff, such as meat, fish, poultry, pork, and the like, wherein the shelf-life of the foodstuff is extended.

It is yet a further principal object of the invention to provide a packaging system for perishable foodstuff that prolongs the “bloom” characteristics of meat products, especially red meat products, like beef.

It is still another principal object of the invention to provide a packaging system that traps natural drainage fluids from perishable foodstuff in a sump or reservoir preferably by means of a one-way porous film allowing the transmission and storage of natural liquids away from the foodstuff while also limiting the recontamination by restricting the back flow of liquid to the foodstuff from the sump. Optionally, the one-way porous film may have imbibed thereon a biocidal or biostatic agent.

It is yet another object of the present invention to provide a packaging system utilizing support elements in the form of elevations, so as to engage the bottom or lower side of the porous film to assist in the support the foodstuff positioned on the opposite side, so the foodstuff is maintained in an elevated position, at all times, from the floor of the reservoir avoiding contact and recontamination of the foodstuff with the drainage fluid retained in the sump.

It is yet a further principal object of the invention to provide a packaging system for perishable foodstuff by maintaining an appetizing appearance of the packaged food products by minimizing the visible appearance of the liquid drainage from fresh meat products often critical for customer acceptance.

These and other objects, features and advantages will become readily apparent from the following description of embodiments of the invention and from the accompanying drawings.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of one embodiment of the invention comprising a packaging system, showing a tray and a porous film;

FIG. 2 is an exploded perspective view of the packaging system shown in FIG. 1, showing the tray, porous film and a reservoir along the tray floor having spaced parallel elevated rectangular ridges between lower spaced parallel grooves;

FIG. 3 is a perspective view of a present invention packaging system, showing a tray, porous film, and a meat product covered by an outer film;

FIG. 4 is a top plan view of the packaging system shown in FIG. 3;

FIG. 5 is a side sectional view of the packaging system shown in FIG. 4 taken along line 5-5 of FIG. 4;

FIG. 6 is a magnified sectional view of the tray reservoir illustrating the structural features of the encircled region labeled FIG. 6 of FIG. 5, wherein the porous film is a one-way porous film;

FIG. 7 is a magnified sectional view of the tray reservoir illustrating an alternative embodiment of the structural features of the encircled region labeled FIG. 6 of FIG. 5, wherein the porous film is a two-way porous film;

FIG. 8 is an exploded perspective view of an alternative embodiment of a packaging system as shown in FIG. 1, showing triangular ridges along the reservoir floor;

FIG. 9 is a magnified exploded perspective view of the tray reservoir illustrating the structural features of the encircled region FIG. 9 of FIG. 8;

FIG. 10 is an exploded perspective view of an alternative embodiment of a packaging system as shown in FIG. 1, showing pyramidal support elements along the reservoir floor;

FIG. 11 is a magnified exploded perspective view of the tray reservoir illustrating the structural features of the encircled region FIG. 11 of FIG. 10; and,

FIG. 12 is an exploded perspective view of an alternative embodiment of the packaging system shown in FIG. 1, showing the tray that is black in color, porous film that is black in color and a reservoir along the tray floor having spaced parallel elevated rectangular ridges between lower spaced parallel grooves.

### DETAILED DESCRIPTION OF THE INVENTION

At the outset, it should be appreciated that like drawing numbers on different drawing views identify identical, or functionally similar, structural elements of the invention.

While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

For purposes of the invention, the term “meat” as appearing in the specification and claims is intended to mean generally animal flesh and is not meant to limit meat to describe the flesh of any specific animal. “Meat” products or foodstuff are intended to include, more specifically uncooked or cooked beef, pork, poultry, lamb, seafood, fish products, and combinations thereof, such as sausage products. “Meat” products can also include the flesh of other edible animals, such as ostrich, bison, bear, moose, deer/venison, fowl, and combinations thereof.

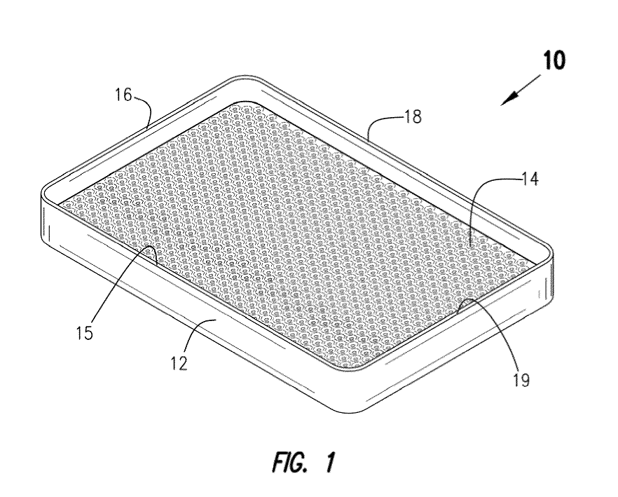

FIG. 1 is a perspective view of one embodiment of the invention comprising packaging system 10. Packaging system 10 comprises tray 12, which comprises a rectangular base. It should be appreciated, however, that the invention is in no way limited to any specific shape, including a rectangular base as is shown in the figures, and that any shape suitable for food products could be used. This includes circular, ovular, square, and triangular shaped trays. The type of food product or more specifically, the shape of the cut of meat will determine the shape of tray necessary. Tray 12 further comprises a continuous, substantially vertical sidewall made up of four sides, sides 15, 16, 18 and 19. It should also be appreciated that a continuous, substantially vertical sidewall with exactly four sides 15, 16, 18 and 19 is a critical element only to the extent that it provides for an elevated arrangement of porous film 14, as is shown below. Thus, it should be appreciated that functionally similar elements, such as a discontinuous sidewall, a sidewall of a different number of sides, or any other support structure known in the art can be used lieu of the continuous substantially vertical sidewall with four sides 15, 16, 18 and 19 to elevate porous film 14.

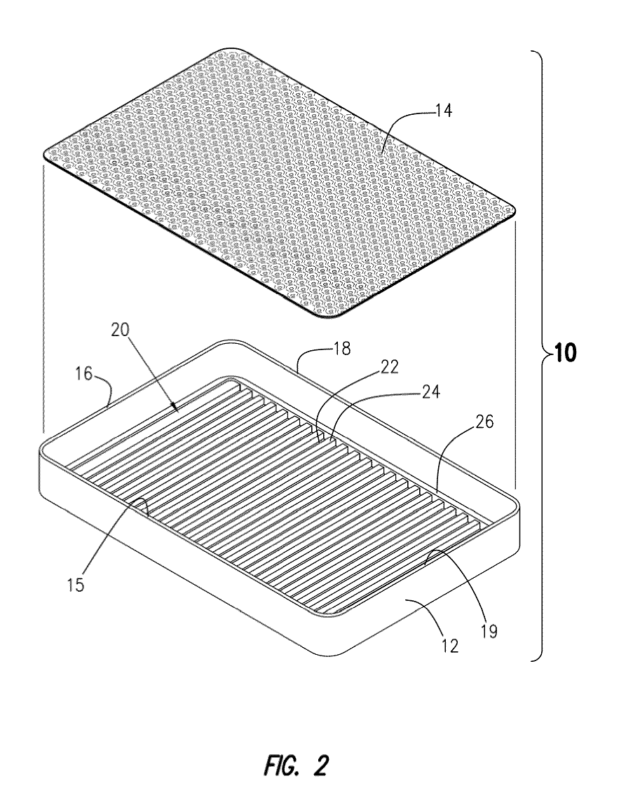

As is more clearly shown in FIG. 2, an exploded perspective view of packaging system 10 shown in FIG. 1, tray 12 further comprises porous film 14 affixed along its peripheral edge to a continuous intermediate interior ledge 26, and reservoir 20 which comprises grooves 22 and ridges 24 holding discharged liquid away from food items, including but not limited to meat products. Ledge 26 is not a critical element of the present invention, but is a preferred means for affixing porous film 14 to the interior edge of the sidewalls of tray 12. Alternatively, porous film 14 can be affixed directly to the upper edges of the sidewalls of tray 12. The term intermediate means that ledge 26 can be disposed within the sidewalls at any height equal to or below the upper edges of the sidewalls of tray 12 and equal to or above reservoir 20. Porous film 14 is preferably affixed to ledge 26 by virtually any means, including heat sealing, the application of contact adhesives, ultrasound welding methods, or any other convenient means known in the art. Ridges 24 are rectangular shaped floor elevations that form at the floor of the reservoir with appropriate channels or grooves 22 there between for holding liquids discharged by the package foodstuff, wherein the ridges and channels together form the reservoir floor, or alternatively stated the tray floor.

The particular configuration of the ridges is not critical, and the elevations need not be parallel as shown, but in some embodiments, ridges 24 preferably rise substantially to the level of ledge 26 to aid in supporting porous film 14. That is, in some preferred embodiments, ridges 24 provide structural support for porous film 14, particularly when the weight of a food item placed atop porous film 14 causes porous film 14 to flex, or bow downwardly. The elevated ridges thus provide desired support for the meat positioned on the porous film, but also serves to elevate and maintain the meat product well above the liquid drained into the reservoir below.

Tray 12 is preferably made by conventional molding methods, but any appropriate manufacturing process known in the art may be used, such as injection molding. Reservoir 20, grooves 22, ridges 24, and ledge 26 can be formed by adding the structural features to the mold of tray 12 during manufacturing. Alternatively, reservoir 20, grooves 22, ridges 24, and ledge 26 can be added after tray 12 has been molded or otherwise formed.

Porous film 14 can be a one-way porous material, or a two-way porous material. Preferably, porous film 14 is a polymeric film or a polymer liner. Most preferable, is a one-way porous polymer liner available under the registered trademark VISPORE® from Tredegar Industries of Richmond, Va., the details of which are disclosed in U.S. Pat. No. 5,614,283. Porous film 14 is adhered to the inner edge of tray 12 at ledge 26 by means of heat sealing, adhesive, as previously mentioned. However, as previously discussed, it should be appreciated that porous film 14 need not be adhered to the inner edge of tray 12 at ledge 26, but that porous film 14 can be adhered directly to the edge of tray 12 along the inner sidewall or upper edge of tray 12. That is, porous film 14 need not be adhered to ledge 26, but instead ledge 26 can be removed from tray 12.

In a preferred embodiment, porous film 14 has pores of adequate diameter and density to allow a fluid to flow through the film. For example, there can be between 40 and 1400 pores per square inch. It should be appreciated that the pore density and pore diameters are in no way limited to a specific range or size, but that any pore density and pore diameter can be used without detracting from the scope of the invention.

Optionally, porous film 14 may comprise a food approved biocidal and/or biostatic agent(s). Preferably, this biocidal agent is at least a biostatic agent, i.e., capable of slowing or inhibiting the growth or reproduction of microorganism, e.g., triclosan, including bacteria, molds, fungi, viruses, and the like. However, it is most preferable that the biocide i.e., life destroying, which may be a bactericide and fungicide, i.e., inhibiting the growth and destroying microorganisms. In some embodiments, the biocide may also be antiviral. It is preferable that the biocide is a broad spectrum biocide, and generally, a wide ranging antimicrobial effect, inhibiting a broad range of microorganisms. Preferably, the biocide is effective at controlling or killing bacteria, such as gram positive, gram negative, aerobic, and anaerobic types, viruses, fungi, etc. Any biocide that is compatible with the porous film before fabrication and will retain its activity after film fabrication may be used in the present invention. A preferred representative biostatic agents include inter-alia triclosan, which is a common name for 2,4,4′-trichloro-2′-hydroxydiphenyl ether or 5-chloro-2-(2,4,-dichlorophenoxy)phenol. It should be appreciated, however, that any biostatic or biocidic agent known in the art and considered safe for food applications may be used. Triclosan is available under the trademark MICROBAN®, a registered trademark of Microban International, Ltd. of New York, N.Y.

Films of the invention containing biocidal and biostatic agents imbibed or impregnated therein, include such members as zinc and silver which may also be employed either alone or in combination with other biostatic and/or biocidal agents. Such films may be prepared by methods known among those skilled in the art, including the steps of mixing the agents with the polymeric material prior to film fabrication. For example, the agents may be directly incorporated throughout the molecular structure of the polymeric film, and essentially will not wash off or wear off. After film fabrication, the agents will slowly diffuse through the polymer to the surface of the film once the biocide and/or biostatic agents on the surface have been depleted, providing continued protection as described in U.S. Pat. No. 6,168,800 (Dobos et al.), which patent is incorporated by reference herein.

Generally, a biocidally or biostatically effective amount of the biocide or biostatic agent is introduced into the film to extend the shelf-life of the food product, including maintaining the red appearance or “bloom” of the meat product, such as beef. More specifically, the biocide is introduced into porous film in an amount from about 0.01% to about 25% by weight of the film, but is more preferably present in an amount between about 1% and about 10% by weight.

In production, the porous film material and biocide are mixed together uniformly and homogenously at a desired ratio, preferably between about 1% and about 10% by weight. Porous film 14 can then be formed by film making procedures known in the art, such as solvent casting, film injection molding and extrusion techniques, such as film blowing. Porous film 14 can then be perforated to a desired pore density and pore diameter. The pores can be formed by mechanical means, embossing means, or any other means known in the art.

FIG. 3 is a perspective view of packaging system 30, an embodiment of the present invention, comprising tray 32, porous film 34, and meat product 36 covered by outer film 38. Packaging system 30 is arranged such that porous film 34 is elevated from the tray floor in support of meat product 36 positioned on porous film 34 having non-porous outer film 38 as the closure, preferably engaged with the meat product. Tray 32, as previously stated, may be fabricated from virtually any food approved plastic/polymer material, foamed or non-foamed type, using processes known in the art.

Optionally, porous film 34 can include a biocide or biostatic agent, as previously discussed. Any biocide or biostatic agent known in the art and generally recognized as safe (GRAS) for food use can be used, such a biostatic agent is that available under the trademark MICROBAN®.

Meat product 36 may be a steak or any other uncooked or cooked perishable foodstuff, but it should be appreciated that the present invention is in no way limited to meat products per se. However, the invention is intended to include the packaging trays and packaging systems, as herein described together in combination with the foodstuff packaged therein. The term “meat” as appearing in the specification and claims is intended to include both fresh and cooked products selected from the group consisting of beef, pork, poultry, lamb, seafood, fish products, and combinations thereof. The term “meat” is also intended to be inclusive flesh of other animals, such as ostrich, bison, bear, moose, deer, fowl, and combinations thereof.

Meat product 36 is disposed atop porous film 34. Thus, porous film 34 will allow any drainage fluids to pass through, below porous film 34. If porous film 34 comprises a biocide, it can substantially suppress any microorganisms present in the drainage fluids from meat product 36, as will be more fully described below.

Outer non-porous film 38 fully covers/wraps tray 32, and preferably engages the entire surface of meat product 36. Outer film 38 further preferably comprises a biocide or combination of biocides, or at least a biostatic agent. It will be understood, the biocides and biostatic agents alone or in combination may be used and methods employed for incorporating into the outer film 38 may be the same as the biocides and biostatic agents used in the methods employed in making the porous film 34, and as previously discussed for porous film 14 of FIGS. 1-2. That is, the outer film material and biocide or biostatic agent(s) alone or in combination can be mixed together uniformly and homogenously at a desired ratio. Outer film 38 can then be formed by film making procedures known in the art, such as solvent casting, film injection molding and extrusion techniques such as film blowing.

If outer film 38 is impregnated with a biocide, the top surface of meat product 36, or alternatively, the surface in contact with outer film 38 is subjected to the biocide impregnated in outer film 38. This diminishes the tendency of meat product 36 to lose its bloom characteristics, that is, diminishes the tendency of the meat to discolor and/or spoil. Stated alternatively, a red meat, such as beef has a natural red color, or bloom, after it has been butchered. After a period of time, the surface of the beef will begin to lose the natural red color, or bloom. The color will begin to fade and become a gray or brownish color. This may be due to microorganisms present in the meat and/or the environment. Outer film 38 preserves the bloom of fresh meat for a longer time than is experienced by packaging systems known in the art, thereby increasing the shelf life and customer acceptance of meat product 36. Optionally, the methods as disclosed herein may be practiced using other methods known in the art, such as gas flushing with inert gases, e.g., nitrogen.

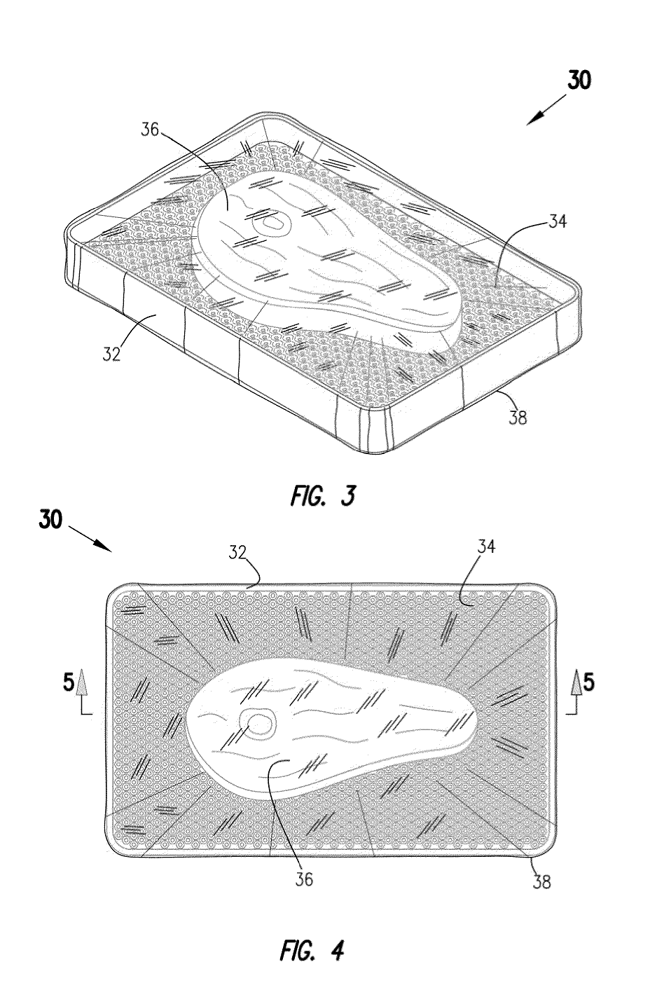

FIG. 4 is a top plan view of packaging system 30 shown in FIG. 3. FIG. 5 is a cross-sectional view of packaging system 30 shown in FIG. 4 taken along line 5-5. Packaging system 30 is shown comprising reservoir 50 collecting drainage 51 from meat product 36. Drainage 51 is collecting in channels 56 formed by grooves 52 and ridges 54. As previously discussed in FIGS. 1-2, grooves 52 and ridges 54 can be of any shape, but that in the present embodiment, they are rectangular shaped. In addition, in some embodiments, ridges 54 provide structural support for porous film 34, especially if the weight of meat product 36 causes porous film 34 to flex, or bow downwardly toward the tray floor.

In a preferred embodiment, meat product 36 is elevated above channels 56, so as to prevent meat product from soaking in the liquid and becoming contaminated, prolonging the shelf life of the package meat. In those embodiments where porous film 34 comprises a biocide, porous film 34 will enhance the shelf-life of meat product 36 by eliminating substantially all microorganisms from drainage 51.

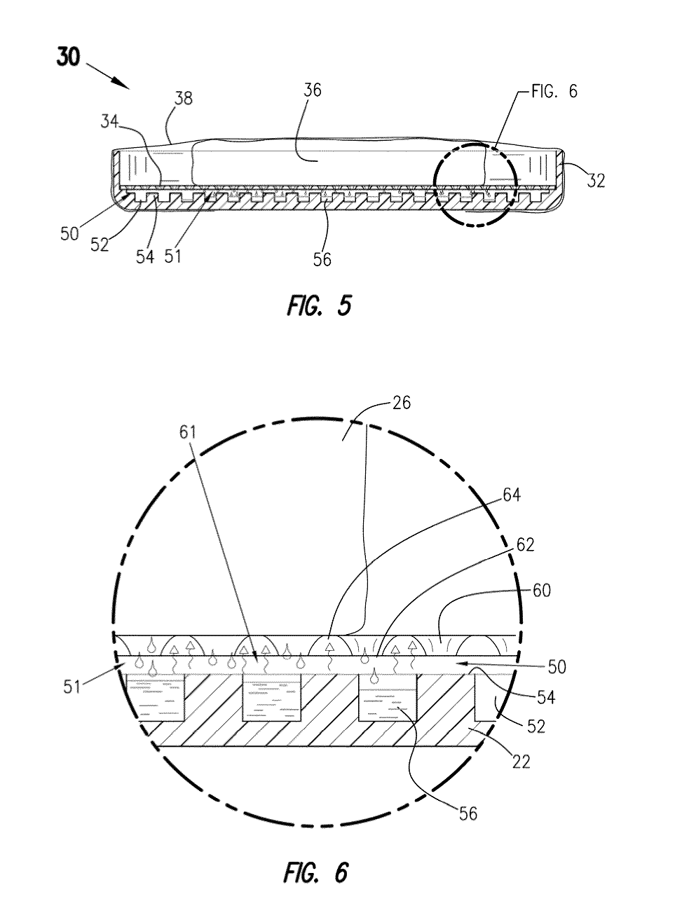

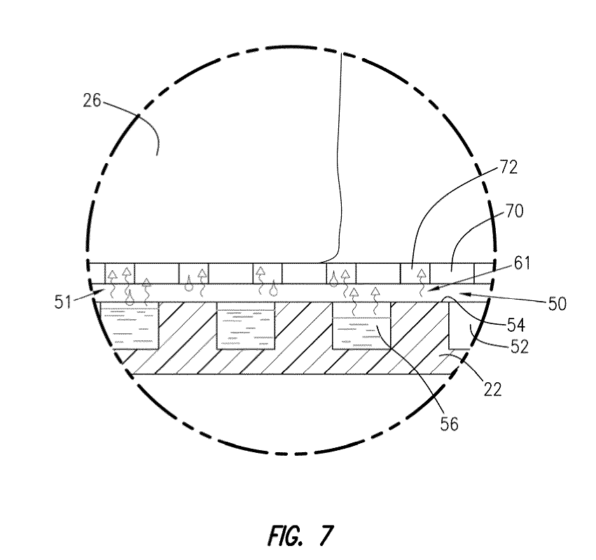

FIG. 6, a magnified sectional view of tray 32 and reservoir 50, illustrates the structural features of the encircled region labeled FIG. 6 of FIG. 5, wherein the porous film is a one-way porous film. FIG. 6 shows drainage 51 flowing through pores 62 of one-way porous film 60. In some aspects, the drainage evaporates and is trapped in cavity 64, restricting backflow out of reservoir 50. As previously discussed, one-way porous film 60 may optionally include a biocide or biostatic agent. Alternatively, in another embodiment of the invention, one-way porous film 60 can be replaced by more conventional two-way porous film for greater economy, as shown in FIG. 7.

Two-way porous film 70 of FIG. 7 is shown with pores 72, by which drainage 51 and evaporate 61 can traverse. This embodiment though satisfactory is somewhat less preferred. As previously discussed, in some aspects, porous film 70 may optionally includes a biocide or biostatic agent.

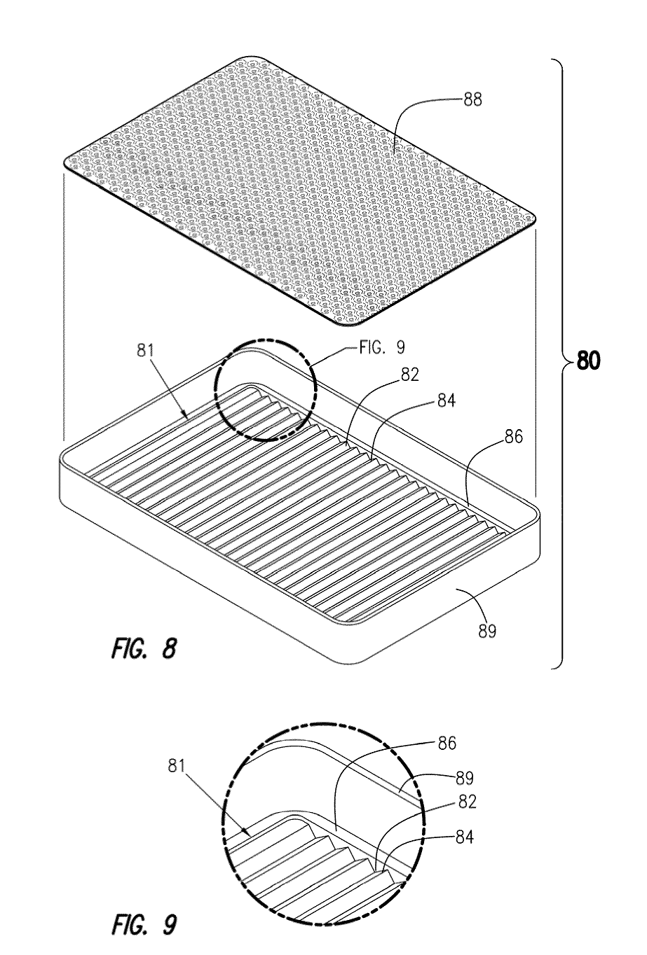

FIG. 8, an exploded perspective view of an alternative embodiment of a packaging system as shown in FIG. 1. Packaging system 80 comprises a tray 89 having a reservoir 81, grooves 82, ridges 84, ledge 86 and porous film 88. Grooves 82 and ridges 84 form triangular channels for drainage, as pointed out below. Porous film 88 is supported by ledge 86, and may be supported by ridges 84. Reservoir 81, grooves 82, ridges 84, and ledge 86 are formed by adding the structural features to the mold of tray 89 during manufacturing. Alternatively, reservoir 81, grooves 82, ridges 84, and ledge 86 may be added after tray 89 has been molded or otherwise formed.

FIG. 9, a magnified exploded perspective view of tray 89 comprising reservoir 81 with a floor comprising grooves 82, elevated ridges 84 and ledge 86 running on the interior sidewall of the tray all shown in the encircled region FIG. 9 taken from FIG. 8.

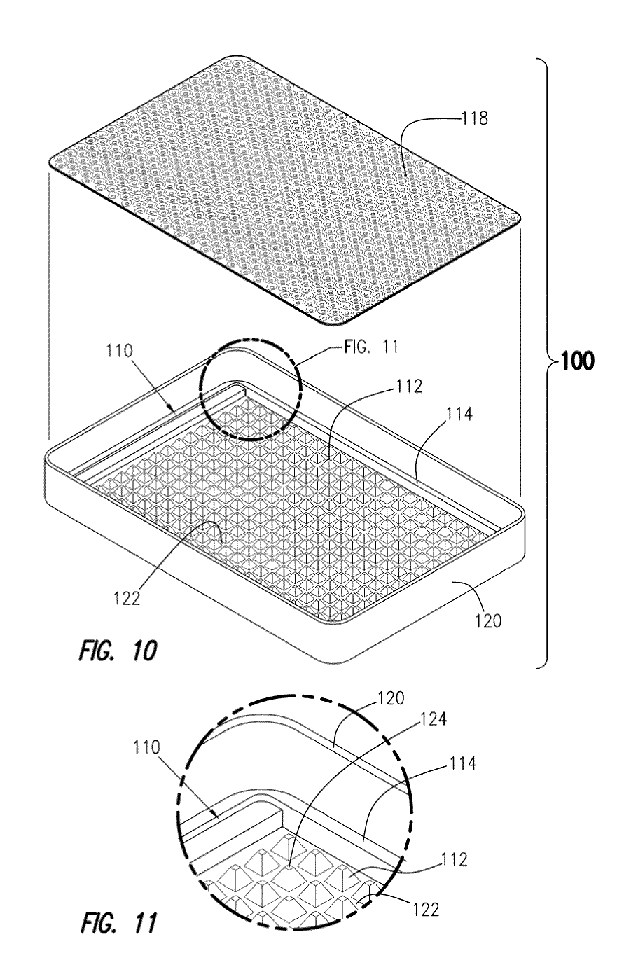

FIGS. 10 and 11 represent an alternative embodiment of a packaging system as shown in FIG. 1. Packaging system 100 comprises a tray 120 with substantially vertical sidewalls, a reservoir 110 having a floor with a grid of elevated pyramidal support elements 112, ledge 114, porous film 118 affixed thereto. Pyramidal support elements 112 form a grid 122 of drainage channels for fluid management transmitted through porous film 118. Details of grid 122 are more clearly shown below in FIG. 11. Porous film 118 is supported by ledge 114 in conjunction with support elements 112. Like other embodiments of the invention, porous film 118 may optionally comprise a biocide, as previously discussed. Reservoir 110, pyramidal support elements 112, and ledge 114 may be formed by adding the structural features to the tray 120 during manufacturing. Alternatively, reservoir 110, support elements 112, and ledge 114 are structural features that may be added after tray 120 has been molded or otherwise formed.

Preferably, pyramidal support elements 112 are in substantial contact with porous film 118 at tips 124. Tips 124 support the weight of porous film 118 as well as the weight of a food product placed atop porous film 118. As with previous embodiments, porous film 118 is preferably a perforated polymeric film with flexible properties to support the foodstuff placed atop film 118.

Alternatively, pyramidal support elements 112 may not be in substantial contact with porous film 118 at tips 124, until a food item is placed atop porous film 118 (not shown). It should also be appreciated that pyramidal support elements 112 are in no way restricted to pyramidal shapes, but other geometrical elevations are contemplated.

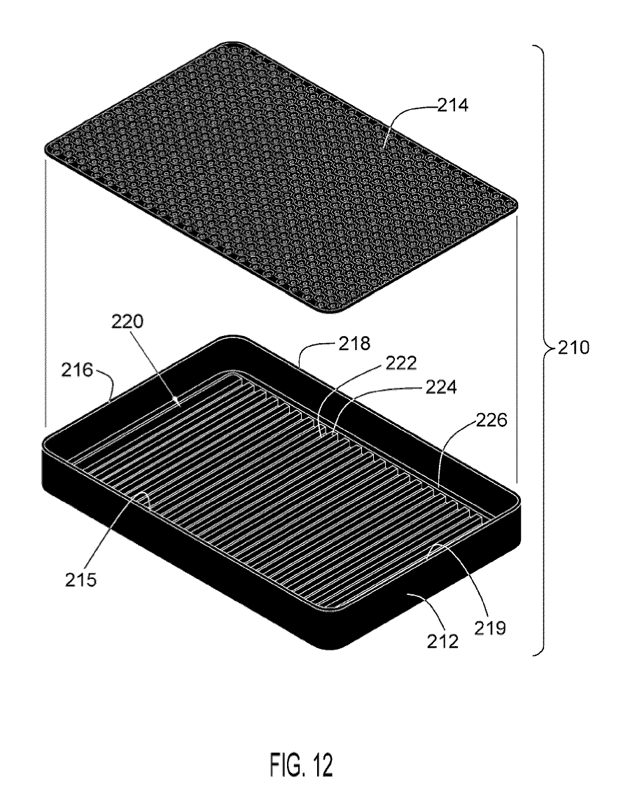

FIG. 12 illustrates an exploded perspective view of an alternative embodiment of the packaging system 210 shown in FIG. 1. Tray 212 is black in color. Tray 212, further comprises porous film 214 affixed along its peripheral edge to a continuous intermediate interior ledge 226, and reservoir 220 which comprises grooves 222 and ridges 224 holding discharged liquid away from food items, including but not limited to meat products. Ridges 224 are rectangular shaped floor elevations that form at the floor of the reservoir with appropriate channels or grooves 222 there between for holding liquids discharged by the package foodstuff, wherein the ridges and channels together form the reservoir floor, or alternatively stated, the tray floor. Tray 212 further comprises a continuous, substantially vertical sidewall made up of four sides, sides 215, 216, 218 and 219. Specifically, porous film 214 is opaque. It should be appreciated that porous film 214 and tray 212 may be any color. However, in a preferred embodiment porous film 214 and tray 212 are black in color. It is particularly advantageous for porous film 214 and tray 212 to be black in color in that it decreases the visible appearance of the descended fluids and/or juices from fresh meat products accumulated in the tray, which is often critical for consumer acceptance. It is further advantageous for porous film 214 to be opaque and black in color to conceal meat juices retained in the tray, which avoids the unsightly appearance of the meat product being in direct contact with fluid absorbent pads that become saturated with the residual fluids from the meat product.

It should be appreciated that in the embodiments recited supra, a biocide is a chemical composition having the ability to inhibit or kill microorganisms such as bacteria, viruses, fungi, and mold, and the like. It should also be appreciated that such a biocide is limited to those safe for food applications, i.e., GRAS. Such a biocide is available under the registered trademark MICROBAN®, but the invention is no way limited to just this exemplary biocide. It should further be appreciated that a biocide may comprise more than one specific chemical composition that is biocidal and/or biostatic.

It should further be appreciated that the invention is intended for perishable foodstuff, such as fresh meats, such as those prepared by a butcher or machine. Fresh meats include timely slaughtered animals, with no restrictions as to origin or species. Thus, most farm animals, for example, are intended within this definition. Examples of common butchered meats include beef, poultry, pork, turkey, duck, lamb, sheep, fowl, seafood, fish, lobster, and combinations thereof. The invention relates generally to both prepared/cooked/smoked/processed and raw variants of meat and meat/sausage products.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A food packaging system comprising:
a tray having peripheral sidewalls; an intermediate interior ledge disposed within said sidewalls, and a floor panel together forming a tray interior, said floor panel comprising a plurality of at least one of spaced elevations, ridges, channels and grooves suitably arranged to form a fluid reservoir or sump for deflecting descending fluids and/or juices discharged by a food product packaged therein away from the food product, and
a food product supporting porous film in said tray interior positioned adjacent to said at least one of spaced elevations, ridges, channels and grooves, and arranged to maintain said food product above said discharged fluid and separated therefrom during the storage period;
wherein each of said plurality at least one of spaced channels and grooves are separated by said plurality of at least one of spaced elevations and ridges.

2. The food packaging system according to claim 1, further comprising a non-porous outer film wrap positioned above said food product on said porous film in said tray interior.

3. The food packaging system according to claim 2, wherein said non-porous outer film wrap is adapted for making contact with said food product which is in contact with said porous film in said tray interior.

4. The food packaging system according to claim 1, wherein said food product supporting porous film comprises a biocidal agent, a biostatic agent, or a combination of a biocidal agent and a biostatic agent.

5. The food packaging system according to claim 2, wherein at least one of said food product supporting porous film and said non-porous outer film wrap comprise a biocidal agent, a biostatic agent, or a combination of a biocidal agent and a biostatic agent.

6. The food packaging system according to claim 3, wherein at least one of said food supporting porous film and said non-porous outer film wrap comprise a biocidal agent, a biostatic agent, or a combination of a biocidal agent and a biostatic agent.

7. The food packaging system according to claim 1, wherein said porous film is a one-way porous film.

8. The food packaging system according to claim 1, wherein said porous film is a two-way porous film.

9. The food packaging system according to claim 7, wherein said one-way porous film comprises a biocidal agent, a biostatic agent, or a combination of a biocidal agent and a biostatic agent.

10. The food packaging system according to claim 8, wherein said two-way porous film comprises a biocidal agent, a biostatic agent, or a combination of a biocidal agent and a biostatic agent.

11. The food packaging system according to claim 1, wherein said spaced elevations or ridges are adapted to engage the porous film to assist in supporting the food product.

12. A disposable meat tray comprising peripheral sidewalls; an intermediate interior ledge disposed within said sidewalls, and a floor panel together forming a tray interior, said floor panel comprising a plurality of at least one of spaced elevations, ridges, channels and grooves suitably arranged to form a fluid reservoir or sump for deflecting descending fluids discharged by meat packaged therein away from the meat, and, a meat supporting opaque porous film in said tray interior positioned adjacent to said at least one of said spaced elevations, ridges, channels and grooves, and arranged to maintain said meat product above said discharged fluids and separated therefrom during storage;
wherein each of said plurality at least one of spaced channels and grooves are separated by said plurality of at least one of spaced elevations and ridges.

13. The disposable meat tray according to claim 12, wherein the meat supporting porous film is a member selected from the group consisting of one-way porous film and two-way porous film.

14. The disposable meat tray according to claim 12, wherein the meat supporting porous film comprises a biocidal agent, a biostatic agent, or a combination of a biocidal agent and a biostatic agent.

15. The disposable meat tray according to claim 12, including a non-porous outer film for enclosing and sealing a meat product in said tray positioned on said meat supporting porous film.

16. The disposable meat tray according to claim 15, wherein the non-porous outer film comprises a biocidal agent, a biostatic agent, or a combination of a biocidal agent and a biostatic agent suitable for enhancing bloom and limiting discoloration of the meat product packaged therein.

17. A meat product packaged in the disposable meat tray of claim 12.

18. A meat product packaged in the disposable meat tray of claim 13.

19. A meat product packaged in the disposable meat tray of claim 14.

20. A meat product packaged in the disposable meat tray of claim 15.

21. A meat product packaged in the disposable meat tray of claim 16.

22. A disposable meat tray comprising peripheral sidewalls; a continuous intermediate interior ledge disposed within said sidewalls, and a floor panel together forming a tray interior, said floor panel comprising a plurality of spaced elevations, suitably arranged on said floor panel, said floor panel forming a single fluid reservoir or sump for receiving descending fluids discharged by meat packaged therein away from the meat, and
a meat supporting opaque porous film in said tray interior wherein the porous film is affixed to the continuous intermediate interior ledge and positioned adjacent to said plurality of spaced elevations and arranged to maintain said meat product above said discharged fluids and separated therefrom during storage.

23. The food packaging system according to claim 1, wherein the food product supporting porous film is opaque.

24. The food packaging system according to claim 1, wherein the food product supporting porous film is black.

25. The food packaging system according to claim 12, wherein the food product supporting porous film is black.

26. The food packaging system according to claim 1, wherein the tray is black.

27. The food packaging system according to claim 1, wherein the intermediate interior ledge is continuous.

28. The food packaging system according to claim 12, wherein the intermediate interior ledge is continuous.

29. The food packaging system according to claim 1, wherein the porous film is affixed to the interior ledge.

30. The food packaging system according to claim 12, wherein the porous film is affixed to the interior ledge.
